(19) United States
(12) Patent Application Publication
(10) Pub. No.: US 2006/0190235 A1
(43) Pub. Date: Aug. 24, 2006

(54) Verilog HDL simulation model for retain time

(75) Inventor: Yu-Yuan Tzeng, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Faraday Technology Corp.

(21) Appl. No.: 11/063,276

(22) Filed: Feb. 22, 2005

(51) Int. Cl. G06F 17/50; G06F 9/45

(52) U.S. Cl. 703/19; 716/6

(57) ABSTRACT

A computer program product for making a machine simulating the behavior of retain and access time of output bus is presented. The computer program product can make a simulator for detecting the transition of an input/bidirectional pin. In the retain time of the related output bus, the simulator sets a variable on in a non-blocking way, and assigns a value to a register of the output bus in a non-blocking way, wherein the value is assigned upon the transition of the input/bidirectional pin. After the retain time, the simulator sets a variable off in a blocking way, assigns the related output bus unknown in a blocking way, assigns the related output bus the value stored in the register in a non-blocking way, and sets the variable on in a non-blocking way.

### BACKGROUND

The present disclosure relates generally to a simulation model, and, more particularly, to a timing model for simulating an output bus of a circuit.

As integrated circuit (IC) designs increase in size and complexity, constructing ICs by reusing intellectual property (IP) is an inevitable trend in IC designs. An IP is reusable only after function and timing is verified. A precise verification method facilitates debugging in the early stages of design flow, thus, reducing development time.

Today, most timing verification adopts the standard delay format (SDF). SDF is an IEEE 1497 standard for storing timing data generated by electronic design automation (EDA) tools in the design process. Timing verification results are derived by simulating an IP with its SDF files.

SDF files define a variety of delay models, including gate, device, interconnect, and port delay models. The retain time model in the port delay category is the focus of this invention. The term “retain time” represents that the time for which an output/bidirectional port will retain its previous logic value after a change of a related input/bidirectional port. FIG. 1 shows the retain time TOH and access time TAA of the bus DO[7:0] with respect to changes of the clock pin clk, where DO is the name of a output bus, [7:0] represents that DO contains 8 digits, from 0^{th} to 7^{th}.

Not all bits in a bus completing a transition at the same time give rise to retain and access time issue. The first changing bit of the bus DO determines the duration of TOH, and the last changing bit of the bus DO determines the duration of TAA. The data is unavailable, after retain time and before access time, shown as cross-line in FIG. 1. During this time, outputs continue to change and accessing at unsettled data can cause function failure.

IP's timing performance is sensitive to temperature, and circuits surrounding the IP, so that a simulation model with back-annotation syntax helps design tools to set the parameters of delay time under different operating environments. At the design stage of constructing IP by hardware description language (HDL), a designer may use as HDL simulation model with back-annotation syntax to increase accuracy. Using both SDF file and HDL simulation models in back-annotation fashion, analysis or verification tools can finely adjust the delay time for different working conditions. For Verilog HDL simulation models, an access time model with back-annotation syntax is as shown below:
(edge_specification input_port=>(output_port_name):3′bx)=(access_time);

The edge_specificaiton can be a rising edge such as posedge or falling edge such as negedge. The input port can be any input port in an IP. The output_port_name can be any related output port, and 3′bx means setting the 3-bit-width output port to unknown. The status unknown, shown in character x, represents that data of output port is unavailable. The access_time is a predetermined access time of the IP. The back-annotation syntax ends with a semicolon.

For example,
(posedge clk=>(DO[7:5]):3′bx)=(90);,
means that when rising edge of clk occurs, 5^{th} to 7^{th} pins of output DO remain unknown for 90 time units, then change to a certain logic value until next rising edge of clk. During the access time, the data of output DO is unavailable. Since access time assignment is in a back-annotated way, 90 time units is a predetermined value and the EDA tools can adjust the access time for different working environments. In short, a back annotated HDL simulation model and a corresponding SDF file can make verification results closely mirror reality

Unfortunately, the existing Verilog HDL simulation tools do not support the retain time model. Designers can only simulate access time behavior, as shown in FIG. 2. The output value DO before retain time is supposed to be a certain value, for simulating what has happened in the reality, but is now unknown. Not only do errors occur when one attempts to access the output value at the retain time, but the simulation results are also mismatched with real results. When it comes to high-end, tight timing constraint designs, retain time models becomes more critical.

There is another way, though, to solve this problem. That is to specify retain time and access time in fixed values in a Verilog HDL simulation model. Since specifying in fixed values does not consist of back-annotation syntax, retain and access times of the IP cannot be revised under different working conditions. Designers must manually tune retain and access time. This is not only a time-consuming task, but also goes against the concept of reusing.

### SUMMARY

Accordingly, a computer program product for making a machine simulating the behavior of retain and access time of an output bus is provided.

The program can make a machine, more specifically, a HDL simulator for detecting the transition of an input/bidirectional pin. In the retain time of the related output bus, the simulator sets a variable on in a non-blocking way, so that an access time model is enabled, and assigns a value to a register of the output bus in a non-blocking way, wherein the value is in response to the transition of the input/bidirectional pin.

After the retain time, the simulator sets off a variable off in a blocking way, so that the access time model is disabled. The simulator also assigns the related output bus as unknown in a blocking way, assigns the related output bus the value stored in the register in a non-blocking way, and sets a variable on in a non-blocking way, so that the access time model is enabled.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the present invention.

FIG. 1 shows the retain time and access time of an output bus with respect to changes on a clock pin;

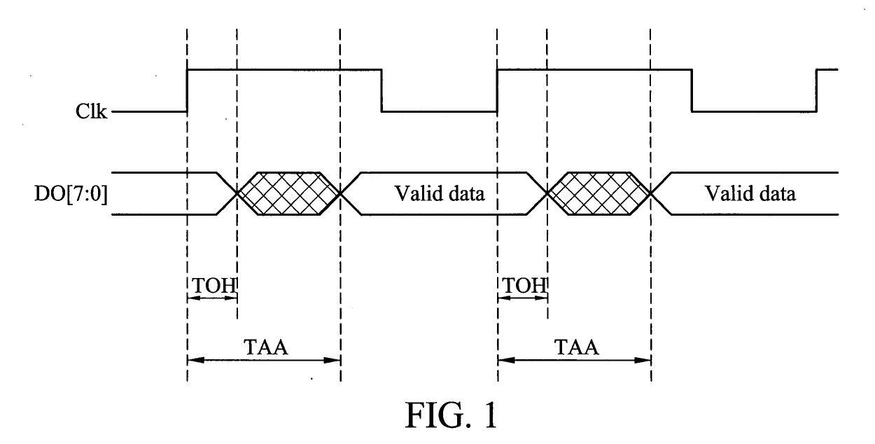

FIG. 2 shows existing verilog simulators failing to simulate retain time of an output bus;

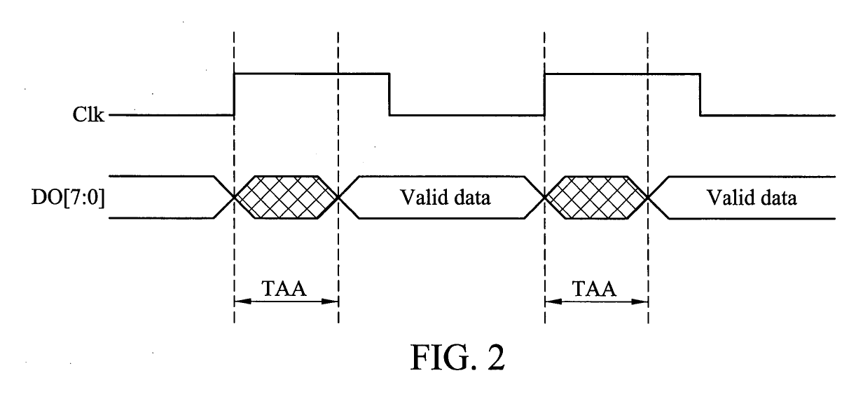

FIG. 3 shows the function block of the retain time model; and

FIG. 4 shows a prototype block diagram of a D flip-flop.

### DETAILED DESCRIPTION

According to an embodiment of the invention, a Verilog HDL (IEEE 1364 standard) simulation model is provided. In a specific block of a Verilog HDL (as known as verilog) simulation model, a variable is allocated to control whether the access time delay model is enabled or not.

For example,
if(flag!==1)(posedge clk=>(DO[0]):1′bx)=(90);.

The above expression shows that “flag” is the variable, and (posedge clk=>(o[0]):1′bx)=(90) is the access time model in back-annotation syntax. Here “flag” is only a name of the variable, and persons in the art should know that the variable can have any name without affecting the result of this invention.

Meanwhile, the variable “flag” is controlled in a function block of the Verilog simulation model.

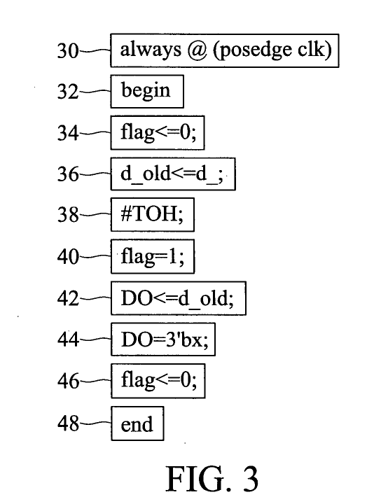

FIG. 3 shows the function block of the Verilog simulation model with labels.

The body of function block starts with step 32, and finishes with step 48. After detecting every rising edge (as known as positive edge) of input pin clk, in step 30, the Verilog simulator executes the instructions in the function block.

The function block shown above can be treated as two parts, separated by step 38, and a detailed description is provided in the following.

Immediately after the rising edge of clk, the Verilog simulator sets the variable flag to be 0 in a non-blocking way, in step 34, so that the condition if(flag!==1) is satisfied, and the access time model is enabled.

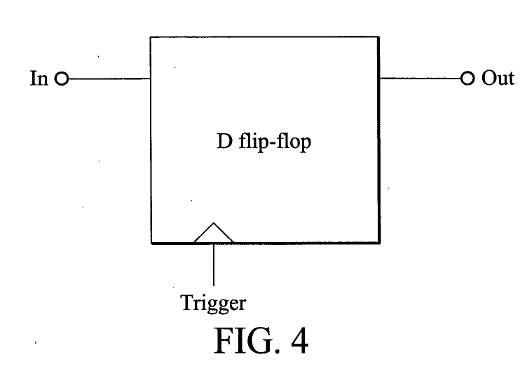

Setting a variable in a non-blocking way is similar to assigning a value to an input of a D flip-flop. The output value is as same as assigned until the D flip-flop is triggered. Symbols “<=” are the expression of non-blocking. FIG. 4 shows a prototype block diagram of a D flip-flop. In the short term, the operation of a D flip-flop is similar to a buffer. After being triggered, the input value is passed to that output.

On the contrary, setting a variable in a blocking way is similar to directly assigning a value to the output of a D flip-flop and the output changes immediately to be the same as assigned. Symbol “=” is the expression of blocking. We will mention blocking again later.

The Verilog simulator also allocates a register d_old to store the output value d_in a non-blocking way, as shown in step 36, wherein the value d_is assigned upon the transition of the input pin clk. Here “d_old” and “d_” are only names of the variable, and those skilled in the art will know that the variable can have any other name without affecting the result of this invention.

The Verilog simulator then pauses, until the end of retain time TOH. The pause is referred to step 38. The 2^{nd} part of the function block now begins.

After the retain time, the Verilog simulator sets the variable “flag” to 1 in a blocking way, as detailed in step 40, so that the access time model is disabled. The simulator also assigns the output port DO to be unknown in a blocking way, as steps 44, and assigns the output pin DO to be d_, which is previous stored in the register d_old in a non-blocking way, as step 42. The Verilog simulator sets the variable “flag” to 0 in a non-blocking way, as step 46, so that the access time model is enabled. Those skilled in the art should recognize that the order of steps from 40 to 46 of the function block does not affect the simulation results.

When the Verilog simulator executes step 48, the contents of output port DO is still unknown, and the variable “flag” also remains 1. This is because both d_old and 1 are assigned in blocking way. When time goes to the end of access time, the Verilog simulator sets the contents of the output port DO to be d_old, and the variable flag to be 0 again. At these point, simulation of retain and access time is completed.

According to another aspect of the invention, the retain time duration can be also expressed in back-annotation in the specific block of a Verilog simulation model.

Any output ports comprising at least two pins encounter retain and access time. Especially in memory or register file circuits. The invention can be widely used in modern IC design industry.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is

1. A computer program product for making a simulator simulating retain and access time of an output port of a circuit, the computer program product comprising:
program code for detecting transition of a input/bidirectional pin;
program code for setting a variable to on in a non-blocking way in the retain time of the circuit, so that an access time model is enabled, and assigning a register to be a value of the output port in non-blocking way, wherein the value is assigned upon the transition of the input/bidirectional pin;
program code for waiting until the end of retain time;
program code for setting a variable to off in a blocking way, disabling the access time model;
program code for assigning the output port to be unknown in a blocking way;
program code for assigning the output port the value stored in the register in a non-blocking way; and
program code for setting a variable on in a non-blocking way, enabling the access time model.

2. The computer program product as claimed in claim 1, wherein the output port comprises at least two pins.

3. The computer program product as claimed in claim 1, wherein the input/bidirectional pin is a clock pin.

4. The computer program product as claimed in claim 1, wherein the retain time duration is less than the access time duration.

5. The computer program product as claimed in claim 1, wherein the access time model is written in back-annotation syntax.

6. The computer program product as claimed in claim 5, wherein the access time model is written in a specific block.

7. The computer program product as claimed in claim 1, wherein the duration of retain time is written in back-annotation syntax.

8. The computer program product as claimed in claim 9, wherein the duration of retain time is written in a specific block.

9. The computer program product as claimed in claim 1, wherein the program, the access time model, and the duration of retain time are written in IEEE standard 1364.

10. The computer program product as claimed in claim 1, wherein the program is readable for a Verilog simulator.
